(19) United States
(12) Patent Application Publication
(10) Pub. No.: US 2026/0106824 A1
(43) Pub. Date: Apr. 16, 2026

(54) DETECTING NETWORK PATH FAILURE IN VIRTUAL NETWORKS

(71) Applicant: Apple Inc., Cupertino, CA (US)

(72) Inventors: Mradul SAXENA, Sunnyvale, CA (US); Surya P. KONERU, Saratoga, CA (US); Varun VIJ, Sunnyvale, CA (US)

(21) Appl. No.: 19/299,321

(22) Filed: Aug. 13, 2025

Related U.S. Application Data
(60) Provisional application No. 63/706,604, filed on Oct. 11, 2024.

(51) Int. Cl. H04L 45/28; H04L 43/16; H04L 45/03

(52) U.S. Cl. CPC H04L 45/28; H04L 43/16; H04L 45/03

(57) ABSTRACT

Systems and methods provide for determining unavailability of physical gateway devices. A virtual switch transmits a probe packet over a virtual network to a first physical gateway device. If a response packet is not received from the first physical gateway device within a threshold amount of time, the virtual switch determines that the first physical gateway device is not available. If the virtual switch determines that the physical gateway device is unavailable, subsequent data packet transmissions are re-routed from the first physical gateway device to a second physical gateway device that differs from the first physical gateway device.

### CROSS-REFERENCE TO RELATED APPLICATIONS

The present application claims the benefit of U.S. Provisional Application No. 63/706,604, entitled “DETECTING NETWORK PATH FAILURE IN VIRTUAL NETWORKS”, filed Oct. 11, 2024, the entirety of which is incorporated herein for reference.

### TECHNICAL FIELD

This disclosure relates to communication networks and in particular to detecting failures are caused by an unresponsive and/or unreachable network gateway.

### BACKGROUND

A virtual network is an abstraction of traditional physical network, where the physical hardware devices like routers, switches, firewalls, and other network services are virtualized and managed through software. These virtual networks enable multiple networks to co-exist on the same physical infrastructure, providing an isolated, customizable network environment for different applications, users, or services. Virtual networks can span across data centers, cloud environments, and even geographical regions, enabling users to manage network resources with more flexibility.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system implementing a virtual computing environment according to aspects of the subject technology.

FIG. 3 illustrates an example of the reachability agent transmitting a sequence of probe packets according to aspects of the subject technology.

FIG. 4 illustrates a flowchart according to aspects of the subject technology.

FIG. 5 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

A virtual network is a network that uses software to manage and control the flow of data, abstracting the underlying physical network infrastructure. It allows multiple isolated network environments to coexist on the shared physical hardware devices, such as servers, network interface cards (NICs), routers, switches, gateways, load balancers, etc. The virtualized approach enables flexibility to manage network traffic and network services entirely through software, eliminating the need to reconfigure physical hardware devices like routers, switches, and firewalls. In traditional physical networks, changes such as adding new hardware devices, adjusting routing rules, or implementing security policies require manual configuration of the physical hardware devices which may be time consuming and prone to errors. However, in virtual networks, these changes done at the software level thereby abstracting the underlying physical network infrastructure.

In an example virtualized network environment, a virtual machine executing on a host server can communicate with a virtual switch executing on a dedicated server configured to facilitate communication between virtual machines on the same host server or across different host servers. To communicate with the virtual switches on other host servers (and/or with other devices), the virtual switch sends the outgoing network traffic through a gateway device corresponding to the host server. The gateway device may be, for example, a physical gateway device or a virtual switch running on a server, such as a commodity server. The physical gateway device forwards the network traffic to, for example, virtual switches on other host servers via an external network. The physical gateway device performs tasks such as IP routing, network address translation (NAT), and packet forwarding to ensure that the virtual machines in the virtual network can communicate with external systems and the Internet.

Despite the abstraction, virtual networks still rely on underlying physical network infrastructure, and failures in the physical layer can have a significant impact such as network outages, data loss, or isolation of virtual machines from critical resources. For example, if the physical gateway device fails in a virtualized network environment, it can lead to issues that disrupt network operations. Failure of a physical gateway device that is responsible for managing the flow of traffic between the virtual network and the external networks can cause network isolation where virtual machines within the virtual network can no longer communicate with external systems. This isolation impacts not only the general connectivity but also access to remote services, external databases other resources outside the virtual network. Virtualized environments rely on external communication for web services, cloud applications and client server interactions. When the physical gateway device fails, these services become unreachable causing disruptions to users and potentially leading to significant downtime for critical business operations. Depending on the network architecture, even internal services provided by same host machine may be affected if they require routing through the physical gateway device. Additionally, network congestion can occur if network traffic is re-routed to other available network paths leading to performance degradation. This is problematic if the network lacks sufficient bandwidth or resources to handle the increased load during the recovery process of the failed physical gateway device.

To overcome such a situation, the subject technology allows the virtual switches to transmit test packets or probe signals to the physical gateway devices. These probes help assess whether the physical gateway devices are responsive and capable of handling network traffic. If the virtual switch detects that a physical gateway device is unavailable, the virtual switch marks the physical gateway device as unavailable. The virtual switch then re-routes network traffic to other available physical gateway devices to maintain the integrity and continuity of network communications. The dynamic detection and re-routing process ensures minimal disruption in data transmission and enhances the resilience of the virtual network.

Compared to traditional Transmission Control Protocol (TCP) fault detection mechanisms, the subject technology offers a more localized and efficient method for detecting network faults. By operating directly within the virtual network, the subject technology can continuously monitor the availability of physical gateway devices without involving the TCP/IP based fault detection techniques (e.g., timeouts). This localized monitoring reduces the need for more complex, higher layer communications, allowing the virtual switch to assess the status of the physical gateway devices in real time. Traditional TCP/IP based fault detection techniques such as TCP keep-alives, typically involves more communication steps introducing overhead and delays that can affect network performance. In contrast, the localized nature of the fault detection processes test packets or probe signals within the local network infrastructure, thereby significantly cutting down on the time needed for packet exchange and decision making. This faster detection translates to quicker rerouting of data packets to other available physical gateway devices, thereby minimizing service disruptions for both TCP and User Datagram Protocol (UDP) based applications.

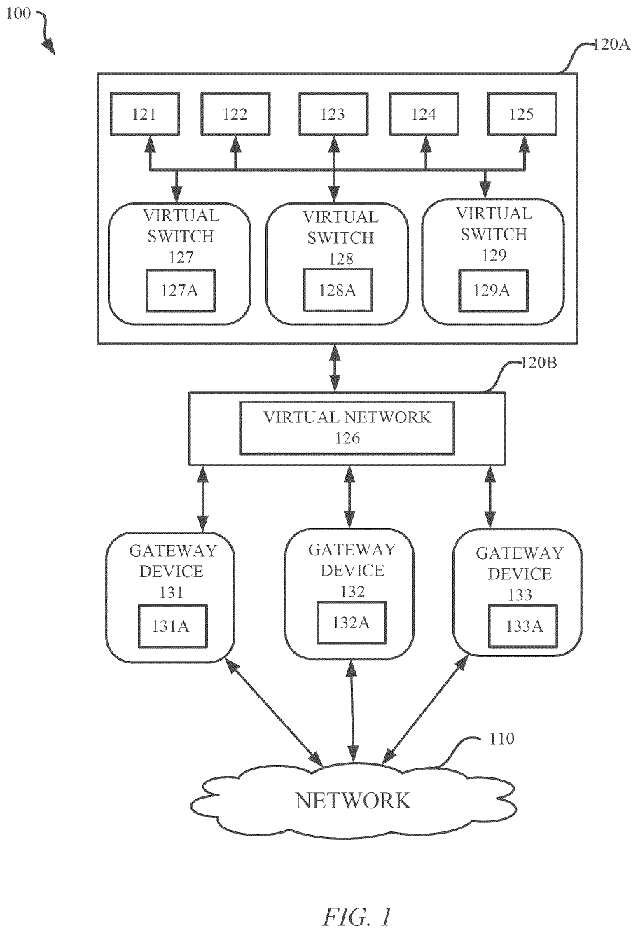

FIG. 1 illustrates an example network environment 100 according to aspects of the subject technology. Not all the depicted components may be used in all implementations, however, and some implementations may include additional or different components than those shown in the figure. Variations in the arrangement and type of the components may be made without departing from the scope of the claims as set forth herein. Additional components, different components, or fewer components may be provided.

The network environment 100 includes a servers 120A that can be a part of a data center executing multiple virtual machines (VMs) 121-125 and virtual switches 127-129. For example, the server 120A can execute a hypervisor that allows creation, execution, and management of VMs 121-125 and virtual switches 127-129 by simulating the hardware resources of the server 120A. The network environment 100 also includes a server 120B that executes a virtual network 126. For example, the server 120B can execute another hypervisor to create and execute a virtual network 126 to allow VMs 121-125 to communicate within themselves and with the network 110. The server 120B further includes physical gateway devices 131-133 that are connected to the network 110 to transmit network data from the virtual switches 127-129 to the network 110. The network 110 is not limited to any particular type of network, network topology, or network media. The network 110 may be a local area network (LAN), a wide area network (WAN). The network 110 may be an interconnected network of devices that may include or may be communicatively coupled to the Internet. For explanatory purposes, the network environment 100 is illustrated in FIG. 1 as connected to the server 120A and server 120B. However, the network environment 100 may include any number of servers and/or other computing/networking devices. Furthermore, for explanatory purposes the servers 120A-B are described herein as single servers; however, each of the servers 120A-B may be representative of any number of servers and/or may be part of the same server.

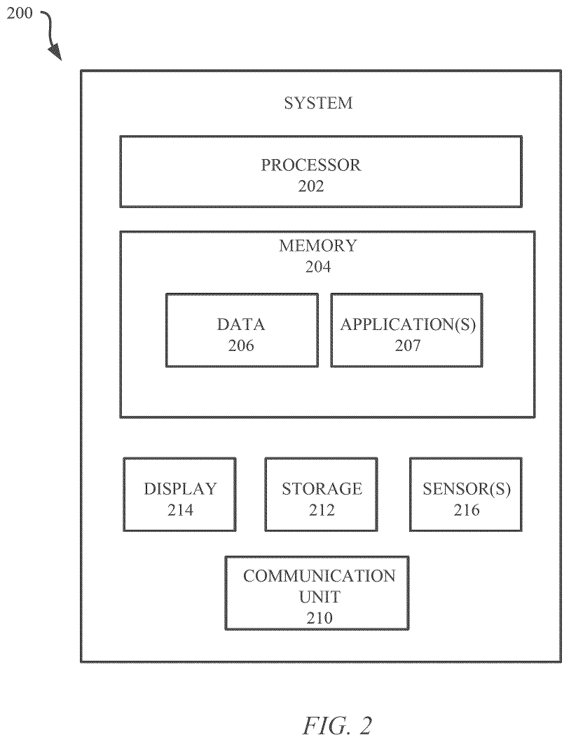

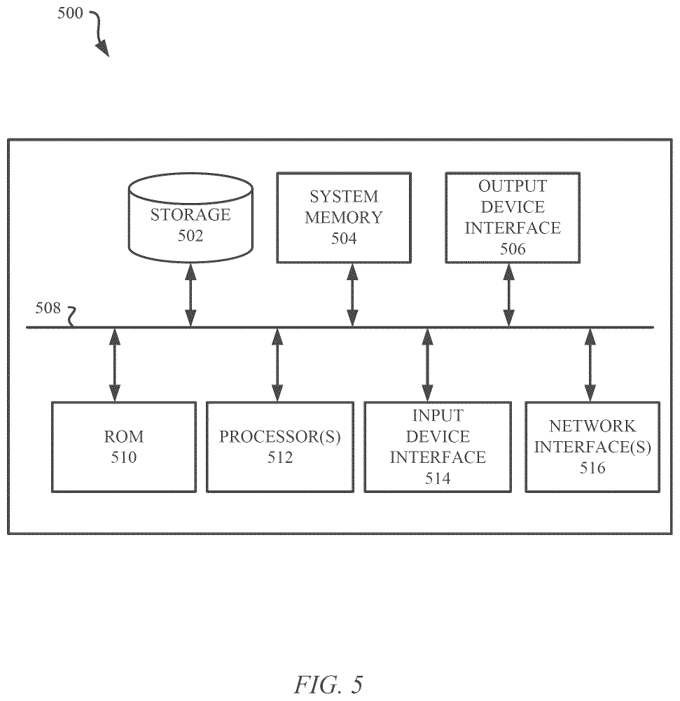

To communicate with the network 110, VMs 121-125 of the server 120A can transmit network data to the virtual switches 127-129 which in turn can transmit the network data to the physical gateway devices 131-133 such as, for example, NICs and/or a physical switching and/or routing device via the virtual network 126 of the server 120B. The physical gateway devices 131-133 performs tasks such as IP routing, NAT, and ensures efficient data flow from the virtual network 126 to the network 110. The virtual switches 127-129 and the physical gateway devices 131-133 further include respective reachability agents 127A-129A and 131A-133A for dynamic detection of network congestion and re-routing of network data in situations where any of the physical gateway devices 131-133 is experiencing heavy processing loads. The techniques and methods of dynamic detection and re-routing of network data is described below. The server 120A and 120B may be, and/or may include all or part of, the systems discussed below with respect to FIG. 2 and/or with respect to FIG. 5.

FIG. 2 illustrates an example system 200 in accordance with some implementations of the subject technology. In an example, the system 200 may be implemented in the server 120A or the server 120B. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more applications 207. In an example, the system 200 may include or may be communicatively coupled with a storage 212. Thus, the storage 212 may be either an internal storage or an external storage. In the example of FIG. 2, the system 200 includes a display 214, and one or more sensors(s) 216. Sensor(s) 216 may include location sensors (e.g., satellite positioning system sensors), motion sensors (e.g., inertial sensors), and/or depth sensors (e.g., LIDAR sensors, radar sensors, time-of-flight sensors, or the like). However, in one or more implementations, the system 200 may not include a display and/or one or more sensors.

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that can be executed, and/or are currently being executed, on the system 200, such as a hypervisor or generally any application. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly. For example, when implemented in the server 120A, the system 200 can execute an application such as a hypervisor to create and/or manage one or more VMs such as the VMs 121-125 and the virtual switches 127-129. As for another example, when implemented in the server 120B, the system 200 can execute another hypervisor to create and/or manage the virtual network 126. These VMs 121-125, the virtual network 126 and the virtual switches 127-129 are contemporaneously executed on the server 120A and the server 120B respectively and managed by their respective hypervisors.

The data 206 may represent, amongst other things, a repository of data processed, received, and generated by one or more processors such as the processor 202. Data may include hardware resource data related to the physical resource of the servers 120A (or the server 120B), such as the processor 202, the CPUs, the GPUs, the memory 204, the storage 212 and network bandwidth. The data 206 may also include VM state data that is related to the status of VMs 121-125, including VM configuration, memory allocation and CPU usage of each of the VMs 121-125. The data 206 can also include network data passing between the VMs 121-125 and the network 110 through virtual switches 127-129.

To determine the availability of the physical gateway devices, the virtual switches 127-129 and the physical gateway devices 131-133 may include a respective reachability agent (e.g., a software application, a code, or a set of instructions) which allows the virtual switches 127-129 to determine whether the physical gateway devices 131-133 are available for transmission of data (e.g., data packets) from the VMs 121-125 to the network 110. For brevity, the techniques, and methods of determining the availability of the physical gateway devices 131-133 is described with reference to the virtual switch 127 and the physical gateway device 131 (also referred to as a first physical gate device 131).

In some embodiments, the reachability agent 127A executing in and/or in conjunction with the virtual switch 127 can generate and transmit a probe packet to a reachability agent 131A executing in and/or in conjunction with the first physical gateway device 131 via the virtual network 126. The probe packet can be a UDP packet that includes a header and the payload. The header can include, for example, a source address, a destination address, a length of the entire data packet, and a checksum that can be used for error checking to ensure the integrity of the probe packet. In this case, the source address is the address of the virtual switch 127, the destination address is the address of the first physical gateway device 131, and the payload may include a timestamp indicating the time when the reachability agent 127A provides the probe packet for transmission. In some embodiments, instead of including the timestamp into the payload of the probe packet, the reachability agent 127A can include data (e.g., a flag variable, an identifier, etc.,) that can be used by the first physical gateway device 131 to determine that the data packet is a probe packet and is different from other data packets received from the virtual switch 127. In such embodiments, the reachability agent 127A can start a timer at the time of providing the probe packet for transmission via the virtual network 126.

In some embodiments, after receiving the probe packet, the reachability agent 131A of the first physical gateway device 131 can respond by generating and transmitting a response packet to the virtual switch 127. Similar to the probe packet, the response packet can include for example, a header and a payload. In this case, the header of the response packet may include the address of the physical gateway device 131 as the source address, the address of the virtual switch 127 as the destination address. In some embodiments, the first physical gateway device 131 may include the timestamp from the probe packet into the payload section of the response packet.

In some embodiments, after receiving the response packet from the first physical gateway device 131 (and/or after a threshold amount of time has elapsed from providing the probe packet for transmission), the reachability agent 127A of the virtual switch 127 can determine whether the response packet was received within a threshold amount of time after providing the probe packet for transmission to the first physical gateway device 131. For example, if the first physical gateway device 131 includes the timestamp from the probe packet into the payload section of the response packet, the reachability agent 127A can extract the timestamp from the response packet and compare the timestamp with the current time, thereby determining the time elapsed since the probe packet was provided for transmission by the virtual switch 127 and when the response packet was received by the virtual switch 127.

In some embodiments, if the time elapsed since the probe packet was provided for transmission by the virtual switch 127 is less than the threshold amount of time, the reachability agent 127A can determine that the first physical gateway device 131 is available to receive data packets from the virtual network 126 (and more specifically from the virtual switch 127) for transmission to the network 110. However, if the time elapsed is more than the threshold amount of time (and/or if a response packet was not received within the threshold amount of time), the reachability agent 127A can determine that the first physical gateway device 131 is unavailable to receive data packets from the virtual network 126 for transmission to the network 110.

In some embodiments, in response to determining that the first physical gateway device 131 is unavailable, the reachability agent 127A can update a forwarding table indicating the unavailability of the first physical gate device 131. The update indicates the first physical gateway device 131 as being unavailable, preventing future network data from being routed through the physical gateway device 131. This adjustment in the forwarding table provides for data packets intended for the unavailable first physical gateway device 131 to be re-routed to one or more alternative physical gateway devices (also referred to as second physical gateway devices) that are available.

In some embodiments, the reachability agent 127A can monitor the availability of multiple physical gateway devices in real time. For example, since the virtual switch 127 is connected to physical gateway devices 131-133 via the virtual network 126, the reachability agent 127A executing on the virtual switch 127 can simultaneously transmit probe packets to a respective reachability agents 131A-133A on each respective physical gateway device 131-133. By receiving and evaluating the response packets from the physical gateway devices 131-133, the reachability agent 127A can determine the availability of each of the physical gateway devices 131-133 in real time. In response to determining the availability of each of the physical gateway devices 131-133, the reachability agent 127A can continuously and/or dynamically update the forwarding table to reflect the availability of the physical gateway devices 131-133. If a physical gateway device becomes unavailable, the forwarding table is updated to ensure that data packets are not sent to the physical gateway device and alternative operational gateways are prioritized. For example, if the first physical gateway device 131 is unavailable, the virtual switch 127 can determine from the forwarding table one or more second physical gateway devices that are available. In this example, assuming that the physical gateway devices 132-133 are available, the reachability agent 127A can instruct the virtual switch 127 to terminate the subsequent data packet transmissions from the virtual switch 127 to the first physical gateway device 131 and re-route the subsequent data packet transmissions from the virtual switch 127 to one or more second physical gateway devices 132-133.

In some embodiments, after terminating the subsequent data packet transmissions from the virtual switch 127 to the first physical gateway device 131, the reachability agent 127A can continue to transmit one or more additional probe packets to the first physical gateway device 131 to monitor the availability of the first physical gateway device 131. For example, while the virtual switch 127 is re-routing the subsequent data packet transmissions to one or more second physical gateway devices 132-133, the reachability agent 127A can contemporaneously transmit one or more additional probe packets to the first physical gateway device 131. For example, the virtual switch 127 can transmit an additional probe packet to the first physical gateway device 131 at regular time intervals.

If the first physical gateway device 131 becomes available to transmit data packets from the virtual network 126 to the network 110, the reachability agent 131A of the first physical gateway device 131 may respond to the one or more additional probe packets by generating and transmitting a response packet for at least some of the one or more additional probe packets to the virtual switch 127. In response to receiving the response packets from the first physical gateway device 131, the reachability agent 127A of the virtual switch 127 can determine that the first physical gateway device 131 is available. For example, the reachability agent 127A can extract a timestamp from the response packets and compare the timestamp with the current time, thereby determining the time elapsed since the additional probe packet was provided for transmission by the virtual switch 127 and when the response packet was received by the virtual switch 127. If the time elapsed since the probe packet was provided for transmission by the virtual switch 127 is less than the threshold amount of time, the reachability agent 127A can determine that the first physical gateway device 131 is available to receive data packets from the virtual network 126 (and more specifically from the virtual switch 127) for transmission to the network 110. However, if the time elapsed is more than the threshold amount of time (and/or if no response is received within the threshold amount of time), the reachability agent 127A still continues to determine that the first physical gateway device 131 is unavailable to receive data packets from the virtual network 126 for transmission to the network 110.

In some embodiments, in response to determining that the first physical gateway device 131 is back online, the reachability agent 127A can update the forwarding table indicating the availability of the first physical gate device 131. The update indicates that the first physical gateway device 131 is available, allowing future network data to be routed through the physical gateway device 131 based on the updated forwarding table.

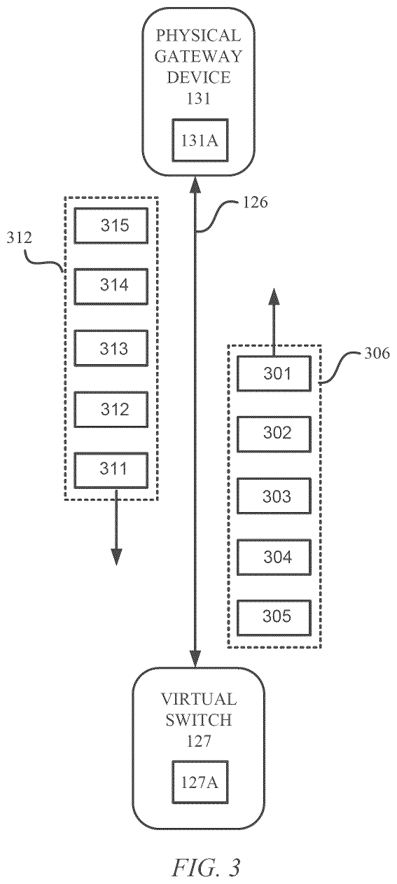

In some embodiments, instead of generating and transmitting a single probe packet to the first physical gateway device 131, the reachability agent 127A of the virtual switch 127 can generate and transmit a sequence of probe packets to the first physical gateway device 131 via the virtual network 126. This is further described with reference to FIG. 3.

FIG. 3 illustrates an example use case where the reachability agent transmits the sequence of probe packets 306 to the first physical gateway device 131 via the virtual network 126. As seen in FIG. 3, the sequence of probe packets 306 includes five probe packets 301-305; however, the sequence can include any number of probe packets. By sending a sequence of probe packets 306, the reachability agent can monitor not just the connectivity of the first physical gateway device 131, but also its ability to handle a continuous stream of data packets.

In some embodiments, the reachability agent 127A executing in and/or in conjunction with the virtual switch 127, can transmit the probe packets 301-305 to the first physical gateway device 131 at regular time intervals. For example, the reachability agent 127A can transmit a first probe packet 301 at time t, followed by the second probe packet at t+50 milliseconds, the third probe packet at t+100 milliseconds, the fourth probe packet at t+150 milliseconds and the fifth probe packet at t+200 milliseconds. In response to receiving the sequence of probe packets 306, the reachability agent 131A executing in and/or in conjunction with the first physical gateway device 131 can respond by generating and providing for transmission, a sequence of response packets 312 to the virtual switch 127. In this example, the sequence of response packets 312 include five response packets 311-315, however, the sequence may include any number of response packets which may or may not coincide with the number of transmitted probe packets.

In response to receiving the sequence of response packets 312, the reachability agent 127A of the virtual switch 127 can determine whether the sequence of response packets 312 contains a threshold number of response packets. If the sequence of response packets 312 meets or exceeds the threshold number of response packets, the reachability agent 127A can determine that the first physical gateway device 131 is available. Conversely, if the sequence of response packets 312 includes fewer than the threshold number of response packets, the reachability agent 127A can determine that the first physical gateway device 131 is not available. For example, if the threshold number of response packets is set to three and the virtual switch 127 receives four response packets, exceeding the threshold number of response packets, the reachability agent 127A can conclude that the first physical gateway device 131 is available for receiving data packets from the virtual network 126 for transmission to the network 110. On the other hand, if the virtual switch 127 receives only two response packets, the reachability agent 127A can determine that the first physical gateway device 131 is not available.

In some embodiments, the reachability agent 127A can transmit the probe packets 301-305 in a predefined order. For example, the reachability agent 127A can include identification markers or sequence numbers into the payload of the probe packets to track the flow of probe packets. By sending a sequence of probe packets 306, the reachability agent 127A can monitor not just the connectivity of the first physical gateway device 131, but also its ability to handle a continuous stream of data packets. In such embodiments, the first physical gateway device 131 is expected to transmit the sequence of response packet 312 that coincides with the sequence of probe packets 306. For example, upon receiving the first probe packet 301, the reachability agent 131A of the first physical gateway device 131 can extract the sequence number from the payload of the first probe packet 301 and can include the sequence number in the payload of the first response packet 311. Likewise, the reachability agent 131A can continue to extract the sequence numbers from the payloads of the subsequent probe packets of the sequence of probe packets 306, and transmit a respective response packet containing the appropriate sequence number.

In response to receiving the sequence of response packets 312, the reachability agent 127A executing in the virtual switch 127 can determine whether the sequence of the response packets 312 coincides with the sequence of probe packets 306. If the sequence of response packets 312 aligns with the sequence of probe packets 306, the reachability agent 127A can determine that the first physical gateway device 131 is available. Conversely, if the sequence of response packets 312 does not match the sequence of probe packets 306, the reachability agent 127A can determine that the first physical gateway device 131 is not available. By doing so, the virtual switch 127 can ensure that the probe packets are being processed correctly.

In some embodiments, the reachability agent 127A of the virtual switch 127 can determine the availability of the first physical gateway device 131 based on one or more conditions described above. For example, the reachability agent 127A can determine that the first physical gateway device 131 is available if the sequence of response packets 312 contains a threshold number of response packets, and that the sequence of response packets 312 was received by the virtual switch 127 within a threshold amount of time after providing the sequence of probe packets 306. After having met the two conditions, the reachability agent 127A can determine that the first physical gateway device 131 is available if the sequence of response packets 312 coincides with the sequence of probe packets 306. If any of the conditions is not met, the reachability agent 127A of the virtual switch 127 can determine that the first physical gateway device 131 is unavailable, thereby halting the subsequent transmission of data packets to the first physical gateway device 131 and re-routing the subsequent transmission of data packets to one or more second physical gateway device 132-133 that were determined to be available.

In one or more implementations, the availability of the first physical gateway device 131 may be determined based on a number of response packets received and/or the latency in receiving the response packets over a predetermined window of time. Thus, in the example that utilizes a sequence of probe packets, the predetermined window of time may span across multiple sequences of probe packets.

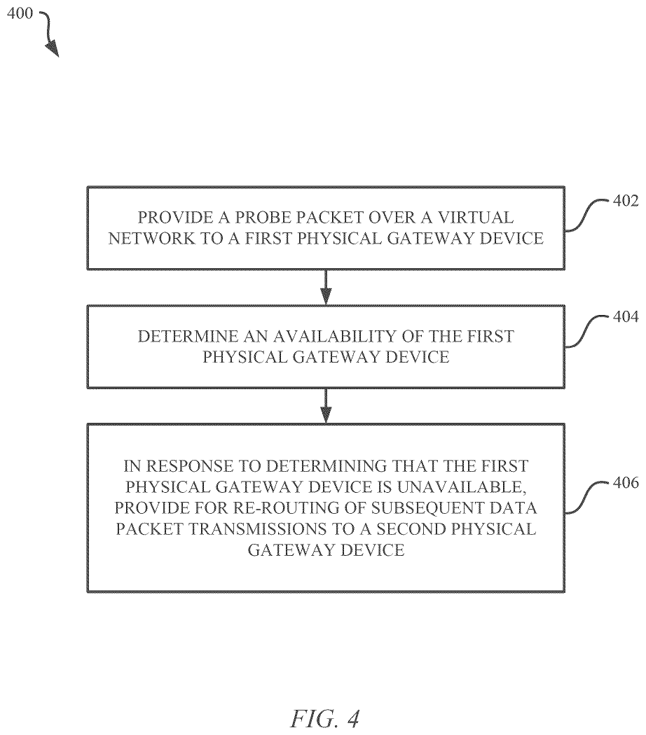

FIG. 4 is a flowchart illustrating an example process 400 for determining an availability of a first physical gateway device according to aspects of the subject technology. For explanatory purposes, the process 400 is primarily described herein with reference to the server 120A and the server 120B of FIG. 1. However, the process 400 is not limited to the server 120A and the server 120B of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the reachability agent 127A executing on, and/or in conjunction with, the virtual switch 127 provides a probe packet for transmission to a first physical gateway device 131. For example, the reachability agent 127A can generate and transmit a probe packet to the first physical gateway device 131 via the virtual network 126. In some embodiments, instead of transmitting a single probe packet, the reachability agent 127A can transmit a sequence of probe packets.

At block 404, the reachability agent 127A of the virtual switch 127 determines an availability of the first physical gateway device. After receiving the probe packet, the reachability agent 131A executing on, and/or in conjunction with the first physical gateway device 131, can respond by generating and transmitting a response packet to the virtual switch 127. After receiving the response packet from the first physical gateway device 131, the reachability agent 127A can determine whether the response packet was received within a threshold amount of time (and/or if no response is received within the threshold amount of time) after providing the probe packet for transmission to the first physical gateway device 131. For example, if the first physical gateway device 131 inserts the timestamp from the probe packet into the payload section of the response packet, the reachability agent 127A can extract the timestamp from the response packet and compare the timestamp with the current time, thereby determining the time elapsed since the probe packet was provided for transmission by the virtual switch 127 and when the response packet was received by the virtual switch 127. If the time elapsed since the probe packet was provided for transmission by the virtual switch 127 is less than the threshold amount of time, the reachability agent 127A can determine that the first physical gateway device 131 is available to receive data packets from the virtual network 126 (and more specifically from the virtual switch 127) for transmission to the network 110. However, if the time elapsed is more than the threshold amount of time, the reachability agent 127A can determine that the first physical gateway device 131 is unavailable to receive data packets from the virtual network 126 for transmission to the network 110.

In one or more implementations, the reachability agent 127A of the virtual switch 127 may maintain a table that stores the sequence number of each transmitted probe packet and the time that the probe packet was provided from transmission. Accordingly, when a response packet is received with a sequence number corresponding to a particular probe packet, the transmission time of the probe packet can be retrieved from the table based on the sequence number.

At block 406, subsequent data packet transmissions are re-routed to a second physical gateway device in response to determining that the first physical gateway device 131 is unavailable. For example, in response to determining that the first physical gateway device 131 is unavailable, the reachability agent 127A can update a forwarding table indicating the unavailability of the first physical gateway device 131. The update indicates that the first physical gateway device 131 is unavailable, preventing future network data from being routed through the first physical gateway device 131. This adjustment in the forwarding table provides for data packets intended for the unavailable first physical gateway device 131 to be re-routed to one or more second physical gateway devices 132-133 that are available.

FIG. 5 illustrates an electronic system 500 with which one or more implementations of the subject technology may be implemented. The electronic system 500 can be, and/or can be a part of, server 120A and the server 120B shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
providing, for transmission, by a virtual switch, a probe packet over a virtual network to a first physical gateway device;
determining, by the virtual switch, an availability of the first physical gateway device over the virtual network based at least in part on whether a response packet was received from the first physical gateway device within a threshold amount of time of providing the probe packet for transmission to the first physical gateway device; and
in response to determining, by the virtual switch, that the first physical gateway device is unavailable over the virtual network, provide for re-routing of subsequent data packet transmissions over the virtual network to a second physical gateway device that differs from the first physical gateway device.

2. The method of claim 1, wherein the probe packet is provided for transmission to the first physical gateway device contemporaneously with providing data packets for transmission to the first physical gateway device.

3. The method of claim 1, further comprising:
providing, for transmission, by the virtual switch, a sequence of probe packets over the virtual network to the first physical gateway device, the sequence of probe packets comprising the probe packet; and
determining, by the virtual switch, the availability of the first physical gateway device over the virtual network based at least in part on whether a sequence of response packets was received from the first physical gateway device within a threshold amount of time of providing the sequence of probe packets for transmission to the first physical gateway device.

4. The method of claim 3, wherein determining the availability of the first physical gateway device comprises determining whether a number of probe packets in the sequence of probe packets is within a threshold amount of the number of response packets in the sequence of response packets received by the virtual switch.

5. The method of claim 4, wherein determining the availability of the first physical gateway device comprises determining that the sequence of probe packets provided for transmission to the first physical gateway device coincides with the sequence of response packets received by the virtual switch from the first physical gateway device.

6. The method of claim 1, wherein re-routing the subsequent data packet transmissions over the virtual network to a second physical gateway device comprises:
terminating the subsequent data packet transmissions from the virtual switch to the first physical gateway device;
determining that the second physical gateway device is available; and
in response to determining that the second physical gateway device is available, re-routing the subsequent data packet transmissions from the virtual switch to the second physical gateway device.

7. The method of claim 6, further comprising:
in response to determining that the first physical gateway device is unavailable, updating a forwarding table to indicate that the first physical gateway device is unavailable.

8. The method of claim 7, further comprising:
in response to terminating the subsequent data packet transmissions from the virtual switch to the first physical gateway device, providing, for transmission, by the virtual switch, one or more additional probe packets over the virtual network to the first physical gateway device to continue to monitor the availability of the first physical gateway device.

9. The method of claim 8, further comprising:
in response to determining that the first physical gateway device is available based at least in part on whether one or more additional response packets were received within the threshold amount of time of providing the one or more additional probe packets for transmission to the physical gateway device:
updating the routing table to indicate that the first physical gateway device is available; and
re-routing the subsequent data packet transmissions from the virtual switch to the first physical gateway device over the virtual network based at least in part on the updated forwarding table.

10. The method of claim 1, the probe packet is provided for transmission by a first reachability agent executing in conjunction with the virtual switch and response packet is received from a second reachability agent executing in conjunction with the first physical gateway device.

11. A non-transitory machine-readable medium comprising instructions that, when executed by one or more processors, cause the one or more processors to perform operations comprising:
providing, for transmission, by a virtual switch, a probe packet over a virtual network to a first physical gateway device;
determining, by the virtual switch, an availability of the first physical gateway device over the virtual network based at least in part on whether a response packet was received from the first physical gateway device within a threshold amount of time of providing the probe packet for transmission to the first physical gateway device; and
in response to determining, by the virtual switch, that the first physical gateway device is unavailable over the virtual network, providing for re-routing of subsequent data packet transmissions over the virtual network to a seconding physical gateway device that differs from the first physical gateway device.

12. The non-transitory machine-readable medium of claim 11, wherein the probe packet is provided for transmission to the first physical gateway device contemporaneously with providing data packets for transmission to the first physical gateway device.

13. The non-transitory machine-readable medium of claim 12, wherein the operations further comprise:
providing, for transmission, by the virtual switch, a sequence of probe packets over the virtual network to the first physical gateway device, the sequence of probe packets comprising the probe packet; and
determining, by the virtual switch, the availability of the first physical gateway device over the virtual network based at least in part on whether a sequence of response packets was received from the first physical gateway device within a threshold amount of time of providing the sequence of probe packets for transmission to the first physical gateway device.

14. The non-transitory machine-readable medium of claim 13, wherein determining the availability of the first physical gateway device comprises determining whether a number of probe packets in the sequence of probe packets is within a threshold amount of the number of response packets in the sequence of response packets received by the virtual switch.

15. The non-transitory machine-readable medium of claim 11, wherein re-routing the subsequent data packet transmissions over the virtual network to a second physical gateway device comprises:
terminating the subsequent data packet transmissions from the virtual switch to the first physical gateway device;
determining that the second physical gateway device is available; and
in response to determining that the second physical gateway device is available, re-routing the subsequent data packet transmissions from the virtual switch to the second physical gateway device.

16. The non-transitory machine-readable medium of claim 11, wherein the operations further comprise:
in response to determining that the first physical gateway device is unavailable, updating a forwarding table to indicate that the first physical gateway device is unavailable.

17. The non-transitory machine-readable medium of claim 16, wherein the operations further comprise:
in response to terminating the subsequent data packet transmissions from the virtual switch to the first physical gateway device, providing, for transmission, by the virtual switch, one or more additional probe packets over the virtual network to the first physical gateway device to continue to monitor the availability of the first physical gateway device.

18. The non-transitory machine-readable medium of claim 17, wherein the operations further comprise:
in response to determining that the first physical gateway device is available based at least in part on whether one or more additional response packets were received within the threshold amount of time of providing the one or more additional probe packets for transmission to the physical gateway device:
updating the forwarding table to indicate that the first physical gateway device is available; and
re-routing the subsequent data packet transmissions from the virtual switch to the first physical gateway device over the virtual network based at least in part on the updated forwarding table.

19. A device comprising:
a memory; and
at least one processor configured to:
provide, for transmission, by a virtual switch, a probe packet over a virtual network to a first physical gateway device;
determine, by the virtual switch, an availability of the first physical gateway device over the virtual network based at least in part on whether a response packet was received from the first physical gateway device within a threshold amount of time of providing the probe packet for transmission to the first physical gateway device; and
in response to a determination, by the virtual switch, that the first physical gateway device is unavailable over the virtual network, provide for re-routing of subsequent data packet transmissions over the virtual network to a second physical gateway device that differs from the first physical gateway device.

20. The device of claim 19, wherein the probe packet is provided for transmission to the first physical gateway device contemporaneously with providing data packets for transmission to the first physical gateway device.
